(19) United States
(12) Patent Application Publication
(10) Pub. No.: US 2013/0051033 A1
(43) Pub. Date: Feb. 28, 2013

(54) ILLUMINATION DEVICE

(71) Applicants: Ryusuke KOTERA, Osaka (JP); Hideharu KAWACHI, Hyogo (JP)

(72) Inventors: Ryusuke KOTERA, Osaka (JP); Hideharu KAWACHI, Hyogo (JP)

(73) Assignee: PANASONIC CORPORATION, Osaka (JP)

(21) Appl. No.: 13/558,609

(22) Filed: Jul. 26, 2012

(30) Foreign Application Priority Data
Aug. 30, 2011 (JP) 2011-187083

(51) Int. Cl. F21V 21/00

(52) U.S. Cl. 362/368

(57) ABSTRACT

An illumination device includes a mounting unit and a light source unit removably mounted to the mounting unit and provided with a flat light emitting panel. The mounting unit includes an engaged portion provided in one end portion of a mounting surface to which the light source unit is mounted and a held portion provided in the other end portion of the mounting surface opposing to one end portion. The light source unit includes a package configured to cover the light emitting panel and an engaging portion and a holding portion arranged on the surface of the package facing the mounting unit. The engaging portion is arranged to engage with the engaged portion. The holding portion is arranged to engage with the held portion. The engaging portion and the holding portion has mutually-opposing slant surfaces. The slant surfaces are inclined toward a center of the light source unit.

### FIELD OF THE INVENTION

The present invention relates to an illumination device in which a solid-state light emitting element such as an organic EL element or the like is used as a light source.

### BACKGROUND OF THE INVENTION

An organic EL element is capable of emitting high-brightness light at a low voltage and capable of producing different emission colors depending on the kind of an organic compound. In addition, the organic EL element can be easily formed into a planar light emitting panel. In recent years, attention is paid to the use of the organic EL element as a light source for an illumination device.

In an illumination device using an organic EL element as a light emitting panel, the light emitting panel needs to be replaced if the light emitting panel reaches its lifespan or if a user wishes to use a light emitting panel differing in size or kind. Therefore, it is desirable that the illumination device using an organic EL element as a light emitting panel be configured so that the light emitting panel can be replaced with ease. For example, Japanese Patent Application Publication No. 2009-129766 discloses an EL illumination device in which a light emitting panel having an organic EL element is used as a light source.

As shown in FIG. 17, the illumination device of this kind includes a mounting unit 100 attached to a ceiling or a wall and a light source unit 200 removably mounted to the mounting unit 100 and provided with a flat organic EL element. The light source unit 200 is mounted to the mounting unit 100 by respectively bringing an engaging portion 210 and a holding portion 220 thereof into engagement with an engaged portion 110 and a held portion 120 of the mounting unit 100.

In the illumination device referred to above, the joint areas between the engaging members (namely, the engaged portion 110, the held portion 120, the engaging portion 210 and the holding portion 220) and the mounting unit 100 or the light source unit 200 are small. For that reason, the engaging members are likely to be broken if the strength of the engaging members is low and if a large force is applied to the engaging members. In case where the size of the engaging members and the joint areas between the engaging members and the mounting unit 100 or the light source unit 200 are increased in an effort to increase the strength of the engaging members, it is likely that the engaging members may interfere with other members. This may lead to an increase in the total thickness of the illumination device.

### SUMMARY OF THE INVENTION

In view of the above, the present invention provides an illumination device having a removably mounted light source unit, which is capable of restraining interference of engaging members with other members while increasing the strength of the engaging members and capable of reducing the total thickness of the illumination device.

In accordance with an embodiment of the present invention, there is provided an illumination device, including: a mounting unit adopted to be attached to a ceiling or a wall; and a light source unit removably mounted to the mounting unit and provided with a flat light emitting panel, wherein the mounting unit includes an engaged portion provided in one end portion of a mounting surface to which the light source unit is mounted and a held portion provided in the other end portion of the mounting surface opposing to said one end portion, the light source unit includes a package configured to cover the light emitting panel and an engaging portion and a holding portion arranged on the surface of the package facing the mounting unit, the engaging portion and the holding portion protruding toward the mounting unit, the engaging portion is arranged to engage with the engaged portion and the holding portion is arranged to engage with the held portion, and the engaging portion and the holding portion have mutually-opposing slant surfaces, the slant surfaces being inclined toward a center of the light source unit so as to increase a joint area of the engaging portion and the holding portion with respect to the package.

The light source unit may be swingable with respect to the mounting unit in a state that the engaging portion engages with the engaged portion. The engaged portion may be provided in one end portion of the mounting surface to be slidable toward the held portion. The held portion may be provided with a holding claw extending toward the engaged portion. The holding portion may be provided with a holding claw engaging with the holding claw of the held portion. The holding claws of the held portion and the holding portion may include engaging surfaces engageable with each other and non-engaging surfaces formed at the opposite sides of the engaging surfaces. And when seen in a vertical cross section taken through the engaged portion and the held portion in a state that the mounting unit and the light source unit are combined together, the holding claw of the held portion may be formed such that a tip end of the holding claw of the held portion on the non-engaging surface is positioned nearer to the mounting unit than a base end of the holding claw of the held portion on the non-engaging surface or the holding claw of the holding portion may be formed such that a tip end of the holding claw of the holding portion on the non-engaging surface is positioned nearer to the light source unit than a base end of the holding claw of the holding portion on the non-engaging surface.

The light source unit may be swingable with respect to the mounting unit in a state that the engaging portion engages with the engaged portion. The engaged portion may be provided in one end portion of the mounting surface to slide toward the held portion. The held portion may be provided with a holding claw extending toward the engaged portion. The holding portion may be provided with a holding claw engaging with the holding claw of the held portion. The holding claws of the held portion and the holding portion include engaging surfaces engageable with each other. When seen in a vertical cross section taken through the engaged portion and the held portion in a state that the mounting unit and the light source unit are combined together, the holding claw of the held portion may be formed such that a tip end of the holding claw of the held portion on the engaging surface is positioned nearer to the light source unit than a base end of the holding claw of the held portion on the engaging surface or the holding claw of the holding portion may be formed such that a tip end of the holding claw of the holding portion on the engaging surface is positioned nearer to the mounting unit than a base end of the holding claw of the holding portion on the engaging surface.

The engaged portion may be provided with an engaging claw extending toward the held portion. The engaging portion may be provided with an engaging claw engaging with the engaging claw of the engaged portion. The engaging claws of the engaged portion and the engaging portion may include engaging surfaces engageable with each other. When seen in a vertical cross section taken through the engaged portion and the held portion in a state that the mounting unit and the light source unit are combined together, the engaging claw of the engaged portion may be formed such that a tip end of the engaging claw of the engaged portion on the engaging surface is positioned nearer to the light source unit than the base end of the engaging claw of the engaged portion on the engaging surface or the engaging claw of the engaging portion may be formed such that the tip end of the engaging claw of the engaging portion on the engaging surface is positioned nearer to the mounting unit than the base end of the engaging claw of the engaging portion on the engaging surface.

The package may include a bevel surface formed by chamfering an end portion of the package which exists near the engaging portion and faces the mounting unit. The package may be configured such that the engaged portion and the engaging portion are positioned to engage with each other when the engaged portion and the engaging portion are moved toward each other in a state that the bevel surface makes contact with the mounting surface of the mounting unit.

The bevel surface may be parallel or substantially parallel to the non-engaging surface of the engaging portion.

The engaged portion may be provided to have a playing gap so that the engaged portion can be tilted with respect to the mounting unit.

The engaged portion may include a salient portion provided on the outer surface thereof facing the held portion and positioned at the side of the light source unit. The salient portion may engage with a step formed in the mounting unit so as to prevent the engaged portion from being separated from the mounting unit.

With such configuration, the regions of the engaging portion and the holding portion leading to the package are formed into slant surfaces. Thus the joint area of the engaging portion and the holding portion with respect to the package grows larger. This helps increase the strength of the engaging portion and the holding portion. This makes it difficult for the engaging portion and the holding portion to interfere with other members. It is therefore possible to reduce the total thickness of the illumination device.

### BRIEF DESCRIPTION OF THE DRAWINGS

The objects and features of the present invention will become apparent from the following description of embodiments, given in conjunction with the accompanying drawings, in which:

FIG. 1 is an exploded perspective view showing an illumination device according to one embodiment of the present invention, as seen from the side of a mounting unit;

FIG. 2 is an exploded perspective view of the illumination device, as seen from the side of a light source unit;

FIG. 3 is a perspective view of the illumination device, as seen from the side of the mounting unit;

FIG. 4 is a section view taken along line IV-IV in FIG. 3;

FIG. 5 is a side view of the illumination device with the light source unit swung with respect to the mounting unit;

FIG. 6 is an enlarged view of the region surrounded by a dot line in FIG. 4;

FIG. 7 is a side section view illustrating the engagement of an engaged portion and an engaging portion making up the illumination device;

FIG. 8 is a perspective view of the engaged portion arranged within the mounting unit;

FIGS. 9A and 9B are section views taken along line IX-IX in FIG. 8, illustrating the sliding movement of the engaged portion within the mounting unit;

FIG. 10 is a perspective view of the engaged portion as seen from the side of the light source unit;

FIG. 11 is a partially sectional perspective view of the engaged portion as seen from the side of the mounting unit;

FIG. 12 is an exploded perspective view showing how the engaged portion is built in the mounting unit;

FIG. 13 is a side section view of the engaged portion arranged within the mounting unit;

FIG. 14A is a side section view showing the engagement of the engaged portion and the engaging portion when the bevel surface of the light source unit is brought into contact with the mounting surface of the mounting unit, and

FIG. 14B is a side section view illustrating a state in which the light source unit is forcibly pushed toward the engaged portion from the state shown in FIG. 14A;

FIG. 15A is a side section view showing the engagement of the mounting unit and the light source unit when the light source unit is swung toward the mounting unit with the light source unit forcibly pushed toward the engaged portion, and FIG. 15B is a side section view illustrating a state that the light source unit is slid toward the held portion from the state shown in FIG. 15A;

FIG. 16A is a side section view showing the contact between the held portion and the holding portion when the light source unit is not forcibly pushed toward the engaged portion but is just swung toward the mounting unit, and FIG. 16B is a side section view showing a state that the holding portion is slid toward the engaged portion from the state shown in FIG. 16A; and

FIG. 17 is a side section view showing a conventional illumination device.

### DETAILED DESCRIPTION OF THE PREFERRED EMBODIMENTS

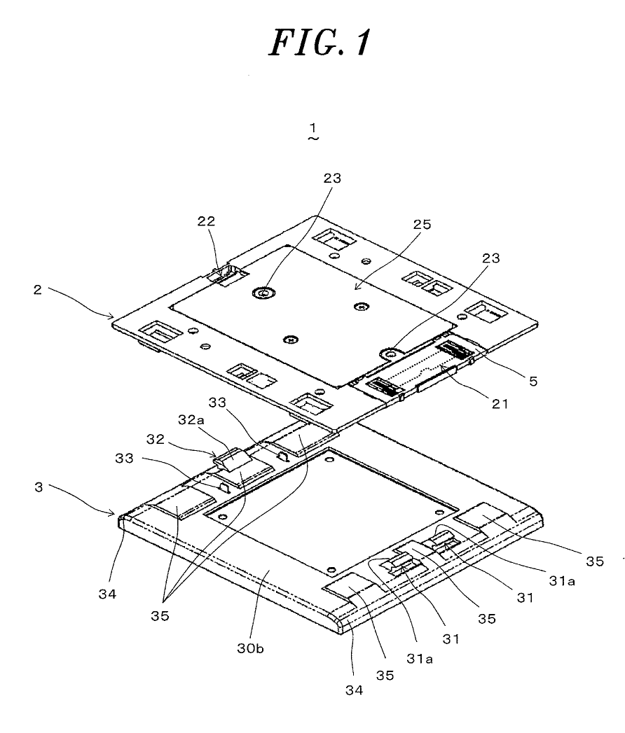

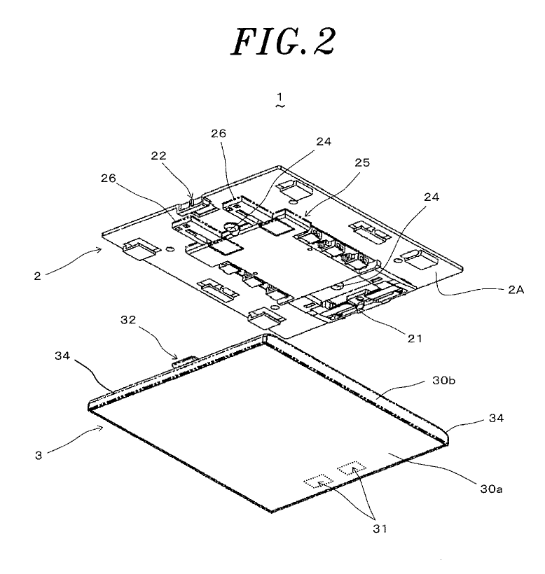

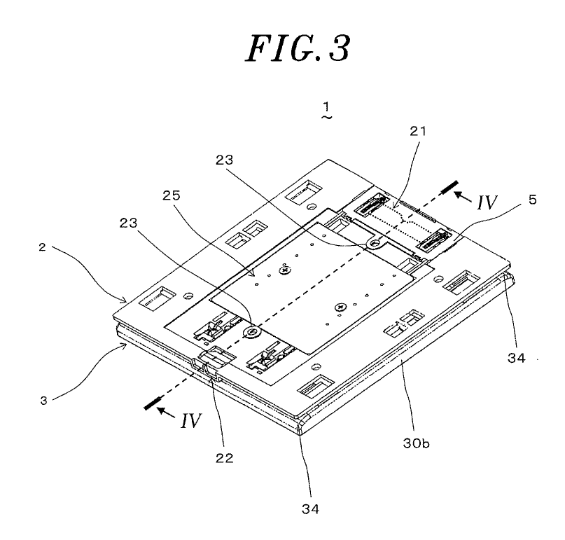

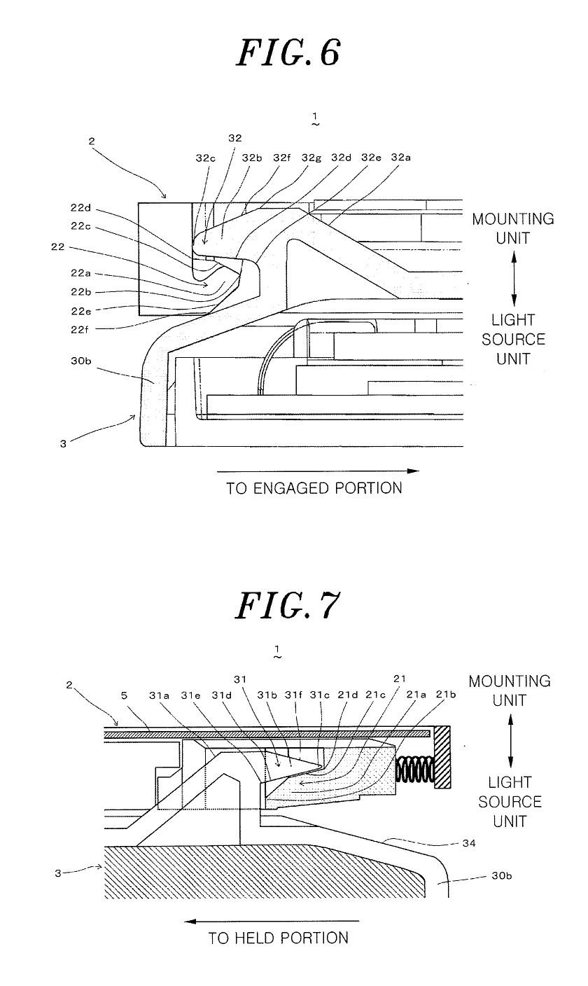

An illumination device according to one embodiment of the present invention will now be described with reference to FIGS. 1 through 5. The illumination device 1 includes a mounting unit 2 attached to a ceiling or a wall and provided with a housing, and a light source unit 3 removably mounted to the mounting unit 2. The mounting unit 2 has a rectangular shape when seen from the side of a light irradiation surface. The mounting unit 2 includes an engaged portion 21 and a held portion 22 provided on a mounting surface 2A on which the light source unit 3 is mounted. The engaged portion 21 is provided in the central area of one side (one end portion) of the rectangular mounting unit 2. The held portion 22 is provided in the central area of the other side (the other end portion) of the rectangular mounting unit 2 opposing to said one side. The light source unit 3 has a rectangular shape when seen from the side of the light irradiation surface. The light source unit 3 includes a flat light emitting panel 40 and a package 30 for accommodating the light emitting panel 40. The light source unit 3 includes an engaging portion 31 and a holding portion 32 provided on the surface of the package 30 facing the mounting unit 2. The engaging portion 31 and the holding portion 32 protrude toward the mounting unit 2. The mutually opposing surfaces 31a and 32a of the engaging portion 31 and the holding portion 32 are formed into slant surfaces inclined toward the center of the light source unit 3 (see FIGS. 6 and 7). Thus the joint area of the engaging portion 31 and the holding portion 32 with respect to the package 30 grows larger. As compared with the conventional engaging members having the same joint area, the engaging portion 31 and the holding portion 32 occupy a reduced space. This helps increase the effective space within the illumination device 1. The engaging portion 31 engages with the engaged portion 21. The holding portion 32 engages with the held portion 22. By the engagement of these engaging members, the light source unit 3 is removably mounted to the mounting unit 2. The light source unit 3 is swingable with respect to the mounting unit 2 in a state that the engaging portion 31 engages with the engaged portion 21 of the mounting unit 2 (see FIG. 5).

The mounting unit 2 is attached to a ceiling or a wall by screws 24 inserted into screw holes 23. The mounting unit 2 includes a circuit board 25 for controlling energization of the light source unit 3 and a terminal reception portion 26 led out from the circuit board 25. A terminal portion 33 of the package 30 protruding toward the mounting unit 2 is inserted into the terminal reception portion 26. As a result, the mounting unit 2 and the light source unit 3 are electrically connected to each other.

The light source unit 3 includes a light emitting panel 40 electrically connected to the terminal portion 33. The light emitting panel 40 is formed of a solid-state light emitting element, e.g., an organic EL element. The organic EL element is formed by, e.g., laminating a light-transmitting substrate, a positive electrode made of a transparent conductive film, a light emitting layer containing a light-emitting organic material, and a light-reflecting negative electrode, in the named order from the side of a light emission surface.

The package 30 includes a cover 30a for covering the light emission surface of the light emitting panel 40 and a case 30b for covering the non-light-emission surface of the light emitting panel 40. The cover 30a is formed of a transparent rectangular flat member. The case 30b is formed into a box shape and is opened on one surface. The cover 30a is attached to the opening of the case 30b. The case 30b is made of, e.g., a plastic material such as an ABS resin, an acryl resin or a polystyrene resin, or a metallic material such as aluminum or the like, the surface of which is subjected to an insulating treatment. The case 30b includes bevel surfaces 34 formed by chamfering the end portion of the case 30b which exists near the engaging portion 31 and faces the mounting unit 2 and by chamfering the end portion of the case 30b which exists near the holding portion 32 and faces the mounting unit 2. The inclination of the bevel surfaces 34 is set such that the engaged portion 21 and the engaging portion 31 are positioned to engage with each other when the light source unit 3 is brought into contact with the mounting surface 2A of the mounting unit 2 through the bevel surface 34 existing near the engaging portion 31 and when the light source unit 3 is moved toward the engaged portion 21 in that state. The case 30b includes a plurality of spacers 35 formed near the engaging portion 31 and the holding portion 32. The spacers 35 create a gap between the light source unit 3 and the mounting unit 2 when the light source unit 3 is mounted to the mounting unit 2.

As shown in FIG. 6, the held portion 22 includes a holding claw 22a extending toward the engaged portion 21. The holding portion 32 includes a holding claw 32b engaging with the holding claw 22a. When seen in the vertical cross section (see FIG. 6) taken through the engaged portion 21 and the held portion 22 with the mounting unit 2 and the light source unit 3 combined together, the tip end 22b of the holding claw of the held portion 22 is positioned nearer to the light source unit 3 (namely, nearer to the light emitting panel 40) than the base end 22d of the holding claw of the held portion 22 on the engaging surface 22c engaging with the holding portion 32. The tip end 22b of the holding claw of the held portion 22 is positioned nearer to the mounting unit 2 (namely, farther from the light emitting panel 40) than the base end 22f of the holding claw of the held portion 22 on the non-engaging surface 22e existing at the opposite side of the engaging surface 22c. Similarly, the tip end 32c of the holding claw of the holding portion 32 is positioned nearer to the mounting unit 2 than the base end 32e of the holding claw of the holding portion 32 on the engaging surface 32d engaging with the held portion 22 and is positioned nearer to the light source unit 3 than the base end 32g of the holding claw of the holding portion 32 on the non-engaging surface 32f. In other words, when seen in the vertical cross section taken through the engaged portion 21 and the held portion 22 with the mounting unit 2 and the light source unit 3 combined together, the holding claw 22a of the held portion 22 is formed such that the tip end 22b of the holding claw 22a of the held portion 22 on the non-engaging surface 22e is positioned nearer to the mounting unit 2 than the base end 22f of the holding claw 22a of the held portion 22 on the non-engaging surface 22e. The holding claw 32b of the holding portion 32 is formed such that the tip end 32c of the holding claw 32b of the holding portion 32 on the non-engaging surface 32f is positioned nearer to the light source unit 3 than the base end 32g of the holding claw 32b of the holding portion 32 on the non-engaging surface 32f.

As shown in FIG. 7, the engaged portion 21 includes an engaging claw 21a extending toward the held portion 22. The engaging portion 31 includes an engaging claw 31b engaging with the engaging claw 21a of the engaged portion 21. When seen in the vertical cross section taken through the engaged portion 21 and the held portion 22 with the mounting unit 2 and the light source unit 3 combined together, the tip end 21b of the engaging claw of the engaged portion 21 is positioned nearer to the light source unit 3 than the base end 21d of the engaging claw of the engaged portion 21 on the engaging surface 21c engaging with the engaging portion 31. The tip end 31c of the engaging claw of the engaging portion 31 is positioned nearer to the mounting unit 2 than the base end 31e of the engaging claw of the engaging portion 31 on the engaging surface 31d engaging with the engaged portion 21. The non-engaging surface 31f of the engaging portion 31 is formed parallel or substantially parallel to the bevel surface 34 existing near the engaging portion 31. In other words, when seen in the vertical cross section taken through the engaged portion 21 and the held portion 22 with the mounting unit 2 and the light source unit 3 combined together, the engaging claw 21a of the engaged portion 21 is formed such that the tip end 21b of the engaging claw of the engaged portion 21 on the engaging surface 21c is positioned nearer to the light source unit 3 than the base end 21d of the engaging claw of the engaged portion 21 on the engaging surface 21c. The engaging claw 31b of the engaging portion 31 is formed such that the tip end 31c of the engaging claw of the engaging portion 31 on the engaging surface 31d is positioned nearer to the mounting unit 2 than the base end 31e of the engaging claw of the engaging portion 31 on the engaging surface 31d.

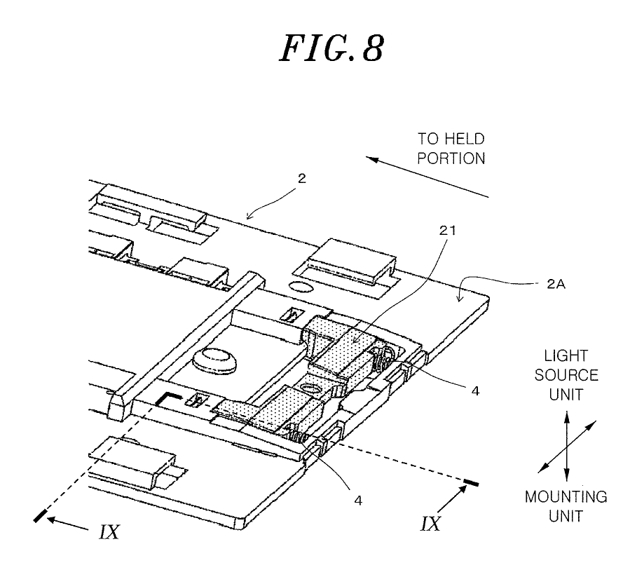

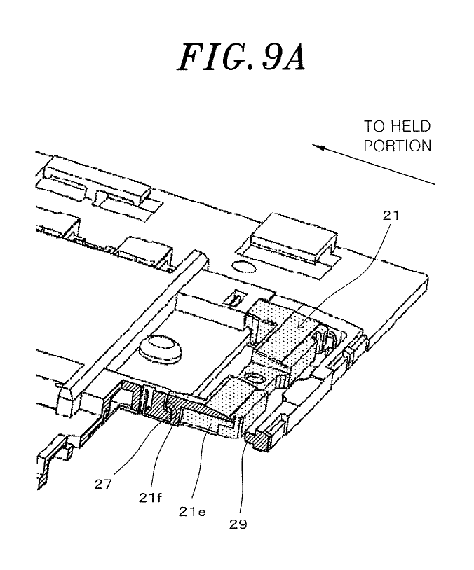

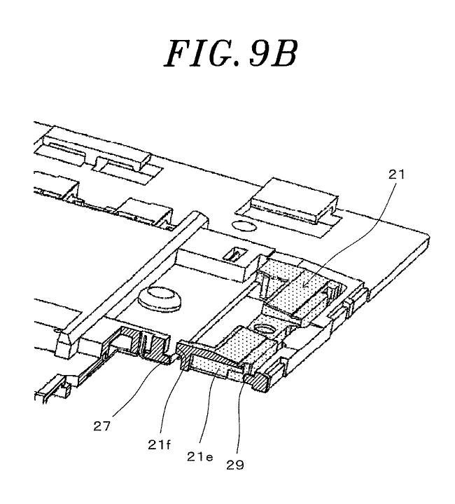

As shown in FIGS. 8 to 9B, the engaged portion 21 (indicated by dots) is resiliently biased toward the held portion 22 by a spring 4 and is mounted to the mounting unit 2 in a slidable manner. FIG. 9A shows a state that the engaged portion 21 positioned closest to the held portion 22, and FIG. 9B shows a state that the engaged portion 21 is positioned farthest from the held portion 22. No spring is shown in FIGS. 9A and 9B.

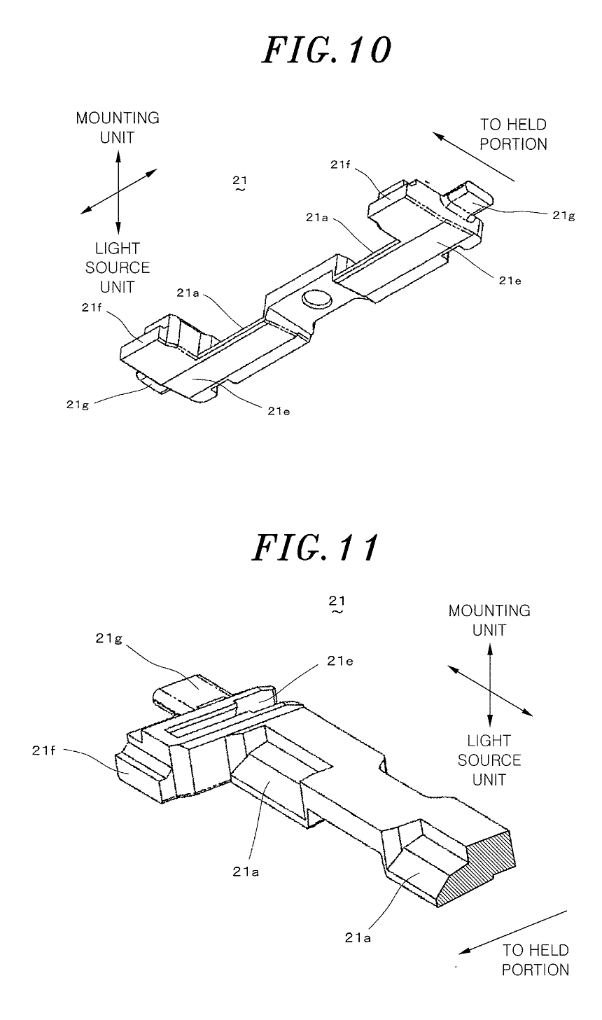

As shown in FIGS. 10 and 11, the engaged portion 21 includes not only the engaging claw 21a stated above but also groove portion 21e provided at the opposite sides of the engaging claw 21a. Each of the groove portions 21e has a groove extending in the direction orthogonal to the extension direction of the engaging claw 21a. The spring 4 is accommodated within the groove. The engaged portion 21 further includes salient portions 21f provided on the outer surface thereof facing the held portion 22 and positioned at the side of the light source unit 3 and protrusion portions 21g protruding from the outer surfaces of the groove portions 21e in the extension direction of the engaging claw 21a. The salient portions 21f engage with the steps 27 of the mounting unit 2, thereby preventing the engaged portion 21 from dropping from the mounting unit 2 (see FIG. 9A). As will be set forth later, the protrusion portions 21g are involved in holding the engaged portion 21 with the mounting unit 2.

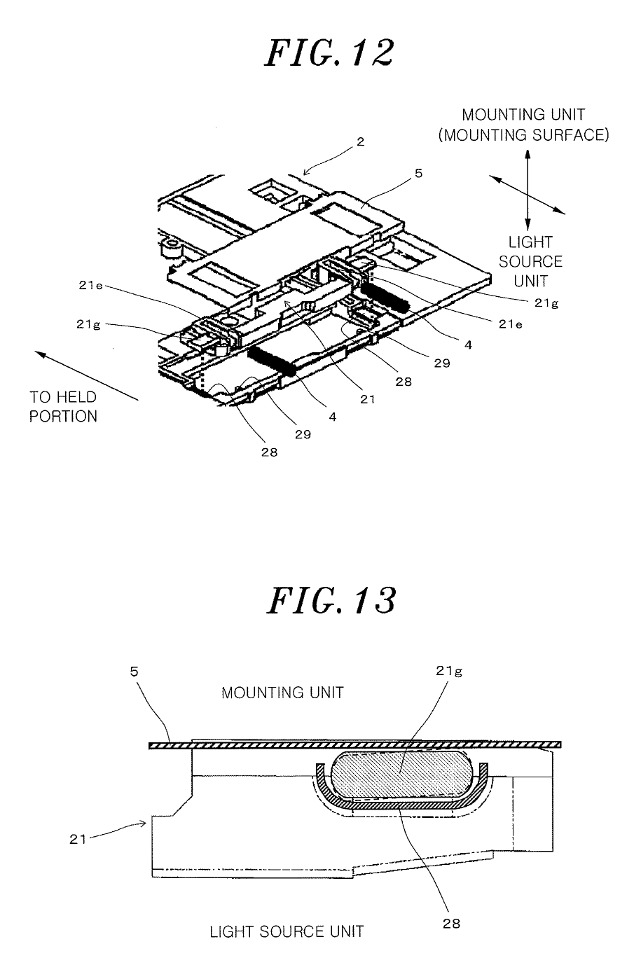

As shown in FIG. 12, the engaged portion 21 is introduced into the mounting unit 2 at the side of the surface (attachment surface) of the mounting unit 2 attached to a ceiling or a wall and is held in the mounting unit 2 with the protrusion portions 21g placed on the support portions 28 of the mounting unit 2. One end of the spring 4 is inserted into each of the groove portions 21e of the engaged portion 21. The other end of the spring 4 is retained by a resilient body support portion 29 provided in the mounting unit 2. A reinforcing plate 5 is arranged on the attachment surface of the engaged portion 21. The reinforcing plate 5 prevents the engaged portion 21 from dropping from the attachment surface. Consequently, as shown in FIG. 13, the engaged portion 21 is held in the mounting unit 2 with the protrusion portions 21g interposed between the support portion 28 of the mounting unit 2 and the reinforcing plate 5. At this time, the engaged portion 21 is provided to have a playing gap so that the engaged portion 21 can be tilted with respect to the support portion 28 (the mounting unit 2) (the protrusion portions 21g in a tilted state is indicated by a dot line in FIG. 13).

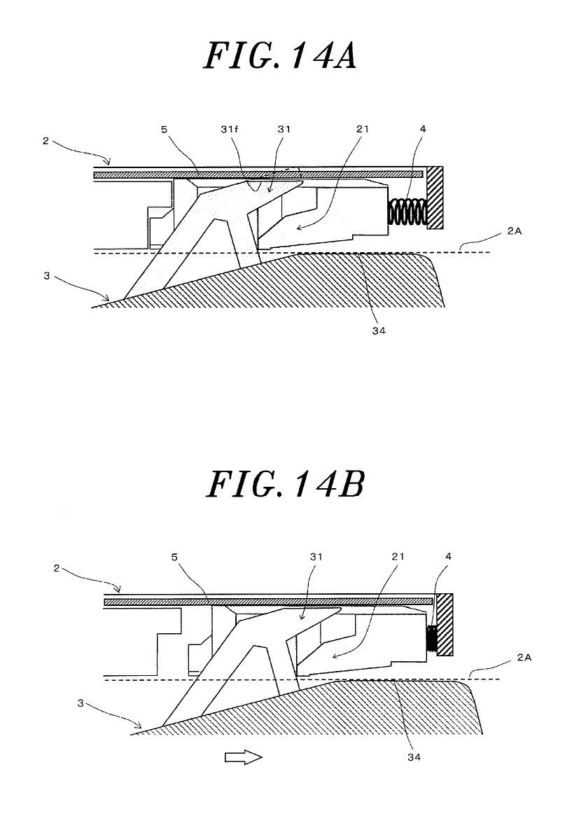

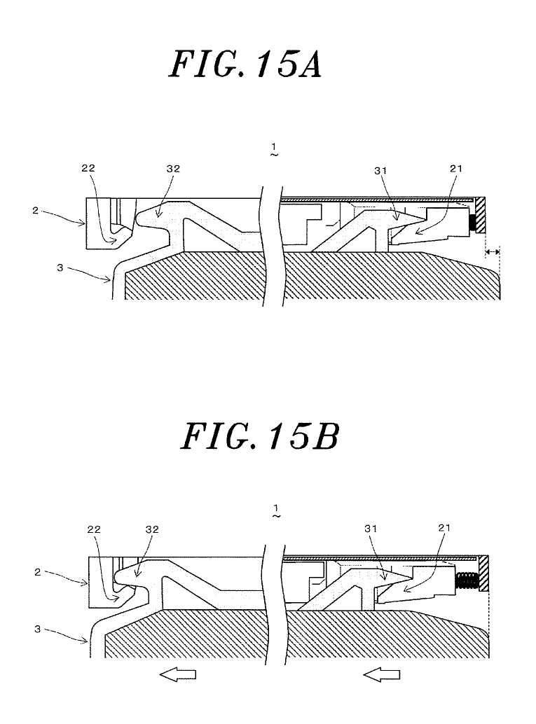

Next, a series of operations for mounting the light source unit 3 to the mounting unit 2 will be described with reference to FIGS. 5 and 14A through 16B. First, the light source unit 3 is moved toward the engaged portion 21 in a state that bevel surface 34 of the light source unit 3 existing near the engaging portion 31 makes contact with the mounting surface 2A of the mounting unit 2 as shown in FIG. 5. As a result, the engaged portion 21 and the engaging portion 31 are positioned to engage with each other as shown in FIG. 14A. At this time, the non-engaging surface 31f of the engaging portion 31 is kept parallel or substantially parallel to the bevel surface 34. Therefore, as compared with a case where an engaging portion 31 having a structure indicated by a dot line in FIG. 14A is employed, it is possible to reduce the area (escape area) required for the mounting unit 2 to accommodate the engaging portion 31. Thereafter, as shown in FIG. 14B, the light source unit 3 is forcibly pushed toward the engaged portion 21 against the resilient force of the spring 4. With the light source unit 3 kept in the forcibly pushed state, the end portion of the light source unit 3 near the holding portion 32 is swung toward the mounting unit 2, thereby pressing the light source unit 3 and the mounting unit 2 against each other. At this time, as shown in FIG. 15A, the held portion 22 and the holding portion 32 do not engage with each other because the light source unit 3 is slid toward the engaged portion 21. If the pushing of the light source unit 3 toward the engaged portion 21 is released in this state, the light source unit 3 is moved toward the held portion 22 as shown in FIG. 15B. Thus the held portion 22 and the holding portion 32 come into engagement with each other. Through the operations stated above, the engaged portion 21 engages with the engaging portion 31 while the held portion 22 engages with the holding portion 32. Eventually, the light source unit 3 is mounted to the mounting unit 2.

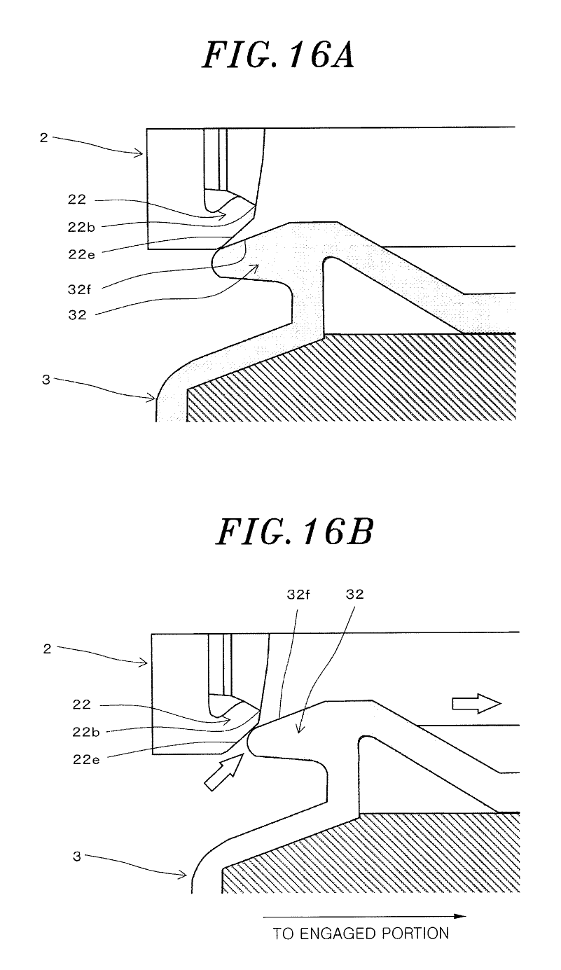

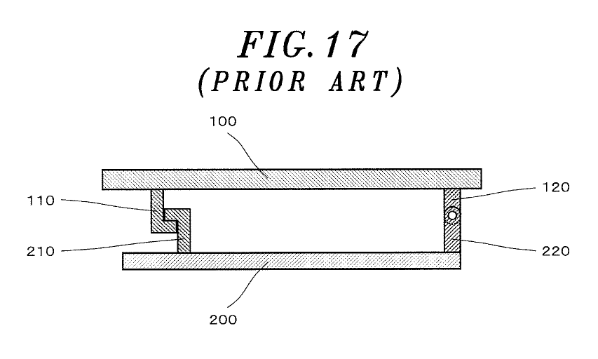

In order to mount the light source unit 3 to the mounting unit 2 through the operations simpler than the operation described above, the light source unit 3 is swung toward the mounting unit 2 in the state shown in FIG. 5 without having to push the light source unit 3 toward the engaged portion 21. In this case, as shown in FIG. 16A, the held portion 22 and the holding portion 32 make contact with each other through the non-engaging surfaces 22e and 32f thereof. In this regard, the non-engaging surfaces 22e and 32f are inclined so that the holding portion 32 can slide on the non-engaging surface 22e of the held portion 22 in such a direction as to engage with the held portion 22. Therefore, as shown in FIG. 16B, the holding portion 32 comes into contact with the held portion 22 and then slides on the non-engaging surface 22e of the held portion 22. At the time point when the holding portion 32 moves past the holding claw tip end 22b of the held portion 22, the holding portion 32 comes into engagement with the held portion 22. In this manner, the light source unit 3 may be mounted to the mounting unit 2 by converting the swing operation force to the sliding force for sliding the light source unit 3 toward the engaged portion 21, using the inclination of the non-engaging surfaces 22e and 32f of the held portion 22 and the holding portion 32.

In order to remove the light source unit 3 from the mounting unit 2, the operations for mounting the light source unit 3 to the mounting unit 2 are performed in the reverse order. In other words, the engagement of the held portion 22 and the holding portion 32 is first released by causing the light source unit 3 to slide toward the engaged portion 21. Then, the end portion of the light source unit 3 near the holding portion 32 is swung in the direction in which the light source unit 3 is removed from the mounting unit 2. Thereafter, the engaging portion 31 is removed from the engaged portion 21. In this regard, the engaging surfaces 21c and 31d of the engaged portion 21 and the engaging portion 31 are inclined so that the engagement of the engaged portion 21 and the engaging portion 31 can be released with ease (see FIG. 7). Since the engaged portion 21 is provided in the mounting unit 2 to have a playing gap, the engaging portion 31 is tilted in an easy-to-remove direction. It is therefore possible to easily remove the engaging portion 31 from the engaged portion 21.

As stated above, the light source unit 3 is removed from the mounting unit 2 by first sliding the light source unit 3 toward the engaged portion 21 and then swinging the light source unit 3. In some cases, however, the light source unit 3 may be directly swung without having to slide the light source unit 3. In this regard, the engaging surfaces 22c and 32d of the held portion 22 and the holding portion 32 are inclined so that the holding portion 32 engaging with the held portion 22 can slide on the engaging surface 22c of the held portion 22 in such a direction as to be removed from the held portion 22 (see FIG. 6). Therefore, even if an attempt to release the engagement of the held portion 22 and the holding portion 32 is made by an erroneous operation or other causes, the holding portion 32 is slid along the engaging surface 22c of the held portion 22 and is rapidly removed from the held portion 22.

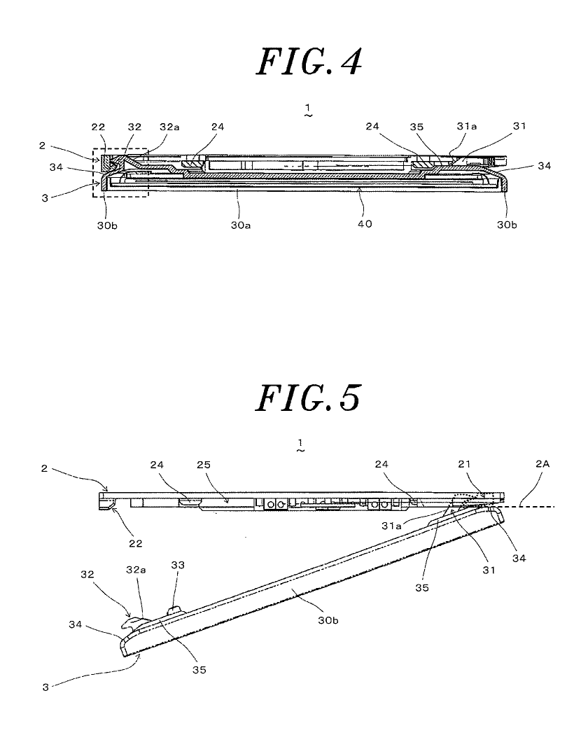

When removing the light source unit 3 from the mounting unit 2, the light source unit 3 is slid toward the held portion 22 by the resilient force of the spring 4 at the time point when the holding portion 32 is removed from the held portion 22. At this time, if the spacers 35 existing near the engaging portion 31 are allowed to interfere with the heads of the screws 24 as shown in FIG. 4, the spacers 35 are placed on the heads of the screws 24, whereby the light source unit 3 floats upward from the mounting unit 2. Consequently, a space for insertion of a finger is created between the light source unit 3 and the mounting unit 2. Thus the task of removing the light source unit 3 can be performed with ease.

With the illumination device 1 of the present embodiment described above, the regions of the engaging portion 31 and the holding portion 32 leading to the package 30 are formed into slant surfaces. Thus the joint area of the engaging portion 31 and the holding portion 32 with respect to the package 30 grows larger. This helps increase the strength of the engaging portion 31 and the holding portion 32. Inasmuch as the effective space within the illumination device 1 gets increased, the interference between the respective members becomes smaller as compared with the conventional illumination device. It is therefore possible to reduce the total thickness of the illumination device 1 and to arrange an increased number of members within the illumination device 1. Since the mutually opposing surfaces 31a and 32a of the engaging portion 31 and the holding portion 32 are formed into slant surfaces, the effective space is formed in the central region of the illumination device 1.

The non-engaging surfaces 22e and 32f of the held portion 22 and the holding portion 32 are inclined so that the held portion 22 and the holding portion 32 can smoothly engage with each other when the held portion 22 and the holding portion 32 are brought into contact with each other through the non-engaging surfaces 22e and 32f. This makes it easy to mount the light source unit 3 to the mounting unit 2.

The engaging surfaces 22c and 32d are inclined so that the engagement of the held portion 22 and the holding portion 32 can be rapidly released when an excessive load is applied to the held portion 22 and the holding portion 32 due to an erroneous operation or other causes. This makes it possible to prevent damage of the held portion 22 and the holding portion 32.

The engaging surfaces 21c and 31d of the engaged portion 21 and the engaging portion 31 are inclined so that the engagement of the engaged portion 21 and the engaging portion 31 can be released with ease when the light source unit 3 is removed from the mounting unit 2. This makes it easy to perform the task of removing the light source unit 3. Since the engaged portion 21 is provided in the mounting unit 2 to have a playing gap, it is easy to remove the engaging portion 31 from the engaged portion 21. It is also unlikely that an excessive force is applied to the engaged portion 21. This makes it possible to prevent damage of the engaged portion 21 and to prevent the engaged portion 21 from dropping from the mounting unit 2.

Since the bevel surfaces 34 are formed in the case 30b, the engaged portion 21 and the engaging portion 31 can be arranged in the mutually engaging positions by merely bringing the bevel surfaces 34 into contact with the mounting surface 2A of the mounting unit 2. This makes it easy to mount the light source unit 3 to the mounting unit 2.

Since the non-engaging surface 31f of the engaging portion 31 is parallel or substantially parallel to the bevel surface 34 of the case 30b existing near the engaging portion 31, it is possible to reduce the height of the mounting unit 2 and to reduce the total thickness of the illumination device 1.

Inasmuch as the engaged portion 21 is provided with the salient portions 21f, the engaged portion 21 is hardly dropped from the mounting unit 2 even before the reinforcing plate 5 is attached in the step of assembling the mounting unit 2 during the manufacturing process. This helps enhance the assembling efficiency of the illumination device 1.

The illumination device according to the present invention is not limited to the embodiment described above but may be modified in many different forms. For example, the light emitting body making up the light source unit is not limited to the organic EL element. Alternatively, the light emitting body may be formed of a solid-state light emitting element such as an inorganic EL element or an LED (Light Emitting Diode). While all the holding claws of the held portion and the holding portion have the slant non-engaging surface in the foregoing embodiment, only one of the holding claws may have the non-engaging surface. Similarly, only one of the holding claws of the held portion and the holding portion may have the slant engaging surface. Only one of the holding claws of the engaged portion and the engaging portion may have the slant engaging surface.

While the invention has been shown and described with respect to the embodiments, the present invention is not limited thereto. It will be understood by those skilled in the art that various changes and modifications may be made without departing from the scope of the invention as defined in the following claims.

What is claimed is:

1. An illumination device, comprising:
a mounting unit adapted to be attached to a ceiling or a wall; and
a light source unit removably mounted to the mounting unit and provided with a flat light emitting panel,
wherein the mounting unit includes an engaged portion provided in one end portion of a mounting surface to which the light source unit is mounted and a held portion provided in the other end portion of the mounting surface opposing to said one end portion,
the light source unit includes a package configured to cover the light emitting panel and an engaging portion and a holding portion arranged on the surface of the package facing the mounting unit, the engaging portion and the holding portion protruding toward the mounting unit,
the engaging portion is arranged to engage with the engaged portion and the holding portion is arranged to engage with the held portion, and
the engaging portion and the holding portion have mutually-opposing slant surfaces, the slant surfaces being inclined toward a center of the light source unit so as to increase a joint area of the engaging portion and the holding portion with respect to the package.

2. The device of claim 1, wherein the light source unit is swingable with respect to the mounting unit in a state that the engaging portion engages with the engaged portion,
the engaged portion is provided in one end portion of the mounting surface to be slidable toward the held portion,
the held portion is provided with a holding claw extending toward the engaged portion,
the holding portion is provided with a holding claw engaging with the holding claw of the held portion,
the holding claws of the held portion and the holding portion include engaging surfaces engageable with each other and non-engaging surfaces formed at the opposite sides of the engaging surfaces, and
when seen in a vertical cross section taken through the engaged portion and the held portion in a state that the mounting unit and the light source unit are combined together, the holding claw of the held portion is formed such that a tip end of the holding claw of the held portion on the non-engaging surface is positioned nearer to the mounting unit than a base end of the holding claw of the held portion on the non-engaging surface or the holding claw of the holding portion is formed such that a tip end of the holding claw of the holding portion on the non-engaging surface is positioned nearer to the light source unit than a base end of the holding claw of the holding portion on the non-engaging surface.

3. The device of claim 1, wherein the light source unit is swingable with respect to the mounting unit in a state that the engaging portion engages with the engaged portion,
the engaged portion is provided in one end portion of the mounting surface to be slidable toward the held portion,
the held portion is provided with a holding claw extending toward the engaged portion,
the holding portion is provided with a holding claw engaging with the holding claw of the held portion,
the holding claws of the held portion and the holding portion include engaging surfaces engageable with each other, and
when seen in a vertical cross section taken through the engaged portion and the held portion in a state that the mounting unit and the light source unit are combined together, the holding claw of the held portion is formed such that a tip end of the holding claw of the held portion on the engaging surface is positioned nearer to the light source unit than a base end of the holding claw of the held portion on the engaging surface or the holding claw of the holding portion is formed such that a tip end of the holding claw of the holding portion on the engaging surface is positioned nearer to the mounting unit than a base end of the holding claw of the holding portion on the engaging surface.

4. The device of claim 1, wherein the engaged portion is provided with an engaging claw extending toward the held portion,
the engaging portion is provided with an engaging claw engaging with the engaging claw of the engaged portion,
the engaging claws of the engaged portion and the engaging portion include engaging surfaces engageable with each other, and
when seen in a vertical cross section taken through the engaged portion and the held portion in a state that the mounting unit and the light source unit are combined together, the engaging claw of the engaged portion is formed such that a tip end of the engaging claw of the engaged portion on the engaging surface is positioned nearer to the light source unit than the base end of the engaging claw of the engaged portion on the engaging surface and the engaging claw of the engaging portion is formed such that the tip end of the engaging claw of the engaging portion on the engaging surface is positioned nearer to the mounting unit than the base end of the engaging claw of the engaging portion on the engaging surface.

5. The device of claim 1, wherein the package includes a bevel surface formed by chamfering an end portion of the package which exists near the engaging portion and faces the mounting unit, the package being configured such that the engaged portion and the engaging portion are positioned to engage with each other when the engaged portion and the engaging portion are moved toward each other in a state that the bevel surface makes contact with the mounting surface of the mounting unit.

6. The device of claim 2, wherein the package includes a bevel surface formed by chamfering an end portion of the package which exists near the engaging portion and faces the mounting unit, the package being configured such that the engaged portion and the engaging portion are positioned to engage with each other when the engaged portion and the engaging portion are moved toward each other in a state that the bevel surface makes contact with the mounting surface of the mounting unit.

7. The device of claim 6, wherein the bevel surface is parallel or substantially parallel to the non-engaging surface of the engaging portion.

8. The device of claim 1, wherein the engaged portion is provided to have a playing gap so that the engaged portion can be tilted with respect to the mounting unit.

9. The device of claim 1, wherein the engaged portion includes a salient portion provided on the outer surface thereof facing the held portion and positioned at the side of the light source unit, the salient portion engaging with a step formed in the mounting unit so as to prevent the engaged portion from being separated from the mounting unit.
